(19) United States
(12) Patent Application Publication
(10) Pub. No.: US 2019/0160427 A1
(43) Pub. Date: May 30, 2019

(54) CORE/SHELL CATALYST PARTICLES AND METHOD OF MANUFACTURE

(71) Applicant: BASF Corporation, Florham Park, NJ (US)

(72) Inventors: Michel Deeba, East Brunswick, NJ (US); Tian Luo, Piscataway, NJ (US); Yunlong Gu, Edison, NJ (US); Emi Leung, Greenwich, CT (US)

(73) Assignee: BASF Corporation, Florham Park, NJ (US)

(21) Appl. No.: 16/302,115

(22) PCT Filed: May 9, 2017
(86) PCT No.: PCT/US17/31636

§ 371 Date: Nov. 16, 2018

Related U.S. Application Data
(60) Provisional application No. 62/341,856, filed on May 26, 2016.

(51) Int. Cl. B01D 53/94; B01J 23/10; B01J 23/63; B01J 35/00; B01J 35/04; B01J 37/00; B01J 37/02; B01J 21/06; F01N 3/20

(52) U.S. Cl. CPC B01D 53/945; B01D 2255/9202; B01J 23/63; B01J 35/008; B01J 35/0013; B01J 35/04; B01J 37/0045; B01J 37/0244; B01J 37/0036; B01J 37/0228; B01J 37/0221; B01J 37/0248; B01J 21/066; F01N 3/20; F01N 3/2066; B01D 2255/1021; B01D 2255/1023; B01D 2255/9155; B01D 2255/9025; B01D 2255/1025; B01D 2255/9022; B01J 23/10

(57) ABSTRACT

The invention provides an automotive catalyst composite effective for abating carbon monoxide, hydrocarbons, and NOx emission in an automotive exhaust gas stream, which includes a catalytic material on a carrier, the catalytic material including a plurality of core-shell support particles comprising a core and a shell surrounding the core, the core including a plurality of particles having a primary particle size distribution d₉₀ of up to about 5 μm, wherein the core particles comprise particles of one or more metal oxides, the shell including nanoparticles of one or more metal oxides, wherein the nanoparticles have a primary particle size distribution d90 in the range of about 5 nm to about 1000 nm (1 μm), and one or more platinum group metals (PGMs) on the core-shell support. The invention also provides an exhaust gas treatment system and related method of treating exhaust gas utilizing the catalyst composite.

### FIELD OF THE INVENTION

The present invention relates to catalyst for coating on monolithic substrates for emission treatment systems and methods of making such catalysts. Also provided are methods for reducing contaminants in exhaust gas streams, such as methods for treating exhaust hydrocarbon and NOx emissions from automotive engines.

### BACKGROUND OF THE INVENTION

Significant reduction in tail pipe hydrocarbon emission is necessary to meet stringent emission regulations. Oxidation catalysts comprising a platinum group metal (PGM) dispersed on a refractory metal oxide support are known for use in treating the exhaust of gasoline or diesel engines in order to convert both hydrocarbon (HC) and carbon monoxide (CO) gaseous pollutants by catalyzing the oxidation of these pollutants to carbon dioxide and water. Such catalysts are generally adhered to ceramic or metallic substrate carriers, which are placed in the exhaust flow path from an internal combustion engine to treat the exhaust before it vents to the atmosphere.

Catalysts used to treat the exhaust of internal combustion engines are less effective during periods of relatively low temperature operation, such as the initial cold-start period of engine operation, because the engine exhaust is not at a temperature sufficiently high for efficient catalytic conversion to occur. Accordingly, reducing hydrocarbon emission during the cold-start period (typically the first few seconds after engine startup) will have great impact on reducing tail pipe emission.

Supported base metal oxides or mixed metal oxides are used as PGM supports in many applications. Supported base metal oxides, such as cerium, titania, lanthana, baria, zirconia as well as many others, are usually dispersed on a high surface refractory oxide, such as alumina, silica, titania, and others. These materials are used to anchor the PGM to minimize PGM sintering and to maintain high dispersion. However, upon high temperature aging, the base metal oxides react with the support and lose their effectiveness as anchor for the PGM. The loss in PGM-base metal oxide interaction can then lead to reduced PGM dispersion and loss of catalytic activity. As an example, cerium oxide supported on alumina or zirconia is a good PGM support due to stabilization of the PGM by the ceria. The ceria acts as an anchor for the PGM which can stabilize the PGM against sintering and therefore minimize the loss in catalytic activity. However, after high temperature calcination or aging, the cerium oxide reacts with the alumina to form corresponding ceria-alumina mixed oxides. This can lead to loss of strong PGM-ceria interaction and eventually loss in catalytic activity.

Another possible utilization of PGM-base metal oxide stabilization is direct PGM doping on the base metal oxide. At fresh conditions, these base metal oxide supports have very high surface area (e.g., 100-200 m²/g) and PGM supported on these materials is a very effective catalytic agent for HC, CO, and NOx activity in environmental applications. However, upon aging to temperatures above 700° C., the base metal oxides will collapse, leading to low surface area in the range of 10 m²/g, collapsed pore structure, and increased particle size. The loss in surface area and porosity lead to loss in PGM dispersion, as well as encapsulation of the PGM within the base metal oxide particles.

There are several patent applications for core/shell materials in diesel applications, where the core is a zeolitic material and the shell is alumina or zirconia.

U.S. Pat. No. 9,120,077 is directed to surface-coated zeolite materials for diesel oxidation applications. Beta-zeolite material surface coated with at least one of zirconia and alumina is provided to both shield the negative interaction between zeolite and the platinum group metal and to increase wash coat porosity by agglomerating small zeolite particles via binding zirconia or alumina. The surface-coated zeolite materials may be prepared via either incipient wetness impregnation of zeolite or by spray-drying mixed zeolite slurry. Spray-dried materials include particles as broken spheres, which leads to higher wash coat porosity.

U.S. Patent Appl. Pub. No. 2014/0170043 is directed to catalytic articles that include a wash coat of platinum group metal on refractory oxide support particles, and further including a molecular sieve wherein greater than 90% of the molecular sieve particles have a particle size greater than 1 μm.

U.S. Pat. No. 6,632,768 is directed to an adsorbent for hydrocarbons in exhaust gas, the adsorbent being an agglomerate of double-structure particles, each of which includes a zeolite core and a ceramic coat wrapping the zeolite core and having a plurality of through-pores communicating with a plurality of pores in the zeolite core. A starting material for the adsorbent is a liquid mixture of an agglomerate of zeolite particles and a ceramic coat-forming precursor solution. Exemplary processes for producing the adsorbent are a flame synthesis method and a spray pyrolysis method.

U.S. Pat. No. 7,670,679 is directed to core-shell ceramic particulates comprising a core particulate structure comprising a plurality of primary particulates and a plurality of primary pores; and a shell at least partially enclosing the core particulate structure. The core comprises a ceramic material such as an oxide, a nitride, a carbide, a boride, or a chalcogenide. The shell may comprise a ceramic material such as an oxide, a nitride, a carbide, a boride, or a chalcogenide or a catalytic material such as transition metals and their oxides. An in-situ process includes mixing a dispersion of core particulate structure and a solution comprising shell material precursor to dispose shell particulates onto the core. An ex-situ process includes disposing shell material onto the core particulate structure either by a dry or a wet chemical means, and the shell material may be disposed either by mechanical or by chemical means.

U.S. Pat. No. 9,101,915 is directed to catalyst particles comprising a layered core-shell-shell structure having a base metal core, a precious metal outer shell, and an intermediate layer comprising a base metal/precious metal alloy between the core and the outer shell.

U.S. Pat. No. 8,911,697 is directed to a catalytically active material for reacting nitrogen oxides with ammonia in the presence of hydrocarbons. The material consists of an inner core made of a zeolite exchanged with one or more transition metals or a zeolite-like compound exchanged with one or more transition metals, the core of the catalytically active material is encased by a shell, which is made of one or more oxides selected from silicon dioxide, germanium dioxide, aluminum oxide, titanium oxide, tin oxide, cerium oxide, zirconium dioxide, and mixed oxides thereof. Individual zeolite particles are impregnated with a solution comprising one or more soluble precursors of the oxides which are to form the shell.

There is a continuing need to provide engine catalysts that are effective to reduce emissions, and whose ingredients are used efficiently while ensuring stability and cost-effectiveness. In addition, there is a continuing need for catalysts that provide efficient catalytic activity across a broad temperature spectrum, including cold start temperatures, and which provide efficient contact between gas phase reagents and the catalytically active components of the catalyst.

### SUMMARY OF THE INVENTION

In one aspect, the invention provides an automotive catalyst composite comprising a catalytic material on a carrier, the catalytic material comprising a plurality of core-shell support particles comprising a core and a shell surrounding the core. The core typically comprises a plurality of particles having a primary particle size distribution d₉₀ of up to about 5 μm, wherein the core particles comprise particles of one or more metal oxides. The shell typically comprises nanoparticles of one or more metal oxides, wherein the nanoparticles have a primary particle size distribution d₉₀ in the range of about 5 nm to about 1000 nm (1 μm). One or more platinum group metals (PGMs) are deposited on the core-shell support. The core-shell support particles are porous, and in certain embodiments, have an average pore radius greater than about 30 Å as measured by N₂ porosimetry. The automotive catalyst composite can be zoned with a different catalytic material along a length of the carrier or layered with a different catalytic material on the carrier. The catalytic material is effective for abating carbon monoxide, hydrocarbons, and NOx emission in an automotive exhaust gas stream.

In certain embodiments, the shell has a thickness in the range of about 1 to about 10 μm. For example, the shell can have a thickness in the range of about 2 to about 6 μm. In one embodiment, the shell has a thickness of about 10 to about 50% of an average particle diameter of the core-shell support. The core of the particles has an exemplary diameter in the range of about 5 to about 20 μm, such as about 5 to about 15 μm. Typically, the core-shell support comprises about 50 to about 95% by weight of the core and about 5 to about 50% by weight of the shell, based on the total weight of the core-shell support. For the overall core-sell support, the average particle diameter is typically in the range of about 8 μm to about 30 μm. In certain embodiments, the core comprises particles of metal oxide having a primary particle size distribution d₉₀ in the range of about 0.1 to about 5 μm.

The metal oxide of the shell and the metal oxide of the core are independently selected and can be, for example, alumina, zirconia, titania, ceria, manganese oxide, zirconia-alumina, ceria-zirconia, ceria-alumina, lanthana-alumina, baria-alumina, silica, silica-alumina, and combinations thereof. The shell can also include a base metal oxide, such as oxides of lanthanum, barium, praseodymium, neodymium, samarium, strontium, calcium, magnesium, niobium, hafnium, gadolinium, manganese, iron, tin, zinc, and combinations thereof. When present, the base metal oxide is typically used in an amount of about 1 to about 20% by weight, based on the weight of the core-shell support particles, more typically about 5 to about 10% by weight.

In certain advantageous embodiments of the invention, the core-shell particles of the invention comprise a core constructed of a plurality of particles of a highly stable refractory metal oxide such as alumina, zirconia, titania, silica, and combinations thereof (e.g., mixed oxides of the foregoing oxide materials). The metal oxide of the shell is advantageously selected to serve as an anchor for the PGM component to minimize PGM sintering, although the metal oxide of the shell can also independently provide useful catalytic or storage functions, with examples including zirconia, titania, ceria, praseodymia, manganese oxide, lanthana, baria, gallium oxide, iron oxide, cobalt oxide, nickel oxide, zinc oxide, and combinations thereof (e.g., mixed oxides of the foregoing materials such as ceria-zirconia).

The PGM component(s) deposited on the shell are selected from the group consisting of platinum (Pt), rhodium (Rh), palladium (Pd), iridium (Ir), ruthenium (Ru), and combinations thereof. Advantageously, the PGM comprises a Pt component, a Pd component, a Rh component, or combinations thereof. For example, the weight ratio of Pt to Pd can be in the range of about 5:1 to about 1:5. The total amount of Pt and Pd is typically about 0.1 to about 5% by weight, based on the total weight of the core-shell support.

In certain embodiments, the shell comprises ceria and the core comprises at least one of zirconia, alumina, ceria-zirconia, and lanthana-zirconia, and wherein the shell comprises the one or more PGMs. In other embodiments, the shell comprises at least one of zirconia and alumina and the core comprises ceria or ceria-zirconia, and wherein the shell comprises the one or more PGMs.

The carrier can be selected from various carriers known in the art, such as a flow-through substrate or a wall-flow filter. A typically loading of the core-shell support particles on the carrier is about 0.5 to about 3.0 g/in³.

The automotive catalyst composite can include further components, such as a refractory metal oxide binder (e.g., alumina, zirconia, or a mixture thereof), or a separate metal oxide component mixed with the core-shell support particles and optionally impregnated with a PGM. In one embodiment, the separate metal oxide component is selected from the group consisting of alumina, zirconia, ceria, and ceria-zirconia, optionally impregnated with a Pt component, a Pd component, a Rh component, or a combination thereof.

The automotive catalyst composite can be used as a single layer catalyst wash coat or as part of a multi-layer structure. For example, the automotive catalyst composite can be used in the form of a single layer gasoline catalyst. In other embodiments, the automotive catalyst composite is in the form of a multi-layer gasoline Three Way Catalyst (TWC catalyst) comprising the core-shell support particles as a first layer and a second layer overlying the first layer comprising a metal oxide and an oxygen storage component (e.g., ceria-zirconia) impregnated with a PGM (e.g., a Pd component, a Pt component, a Rh component, or a combination thereof). In yet another embodiment, the automotive catalyst composite is used in the form of a multi-layer gasoline Three Way Catalyst (TWC catalyst) comprising the core-shell support particles as a first layer, and second layer of metal oxide impregnated with PGM (e.g., a Pt component, a Pd component, or a combination thereof), overlying the first layer, and a third layer overlying the second layer comprising a mixture of metal oxide and an oxygen storage component impregnated with a PGM (e.g., a Pd component, a Rh component, or a combination thereof).

The placement of the automotive catalyst composite of the invention in an exhaust treatment system can vary, and can include placement of the catalytic material containing core-shell support particles in a close coupled or underfloor position of a gasoline exhaust system.

In one particular embodiment, the automotive catalyst composite of the invention is in a form effective as a catalyst to convert hydrocarbons (HC), carbon monoxide (CO), and NOx, and wherein the core comprises particles of one or more metal oxides having a primary particle size distribution d₉₀ in the range of about 0.1 μm to about 5 μm; wherein the shell comprises nanoparticles of one or more metal oxides having a primary particle size distribution d₉₀ in the range of about 5 nm to about 100 nm (0.1 μm); and further comprising one or more platinum group metals (PGMs) deposited on the core-shell support; wherein the core-shell support particles have an average pore radius greater than about 30 Å as measured by N₂ porosimetry.

In another aspect, the invention provides an exhaust gas treatment system comprising the automotive catalyst composite of any of the embodiments set forth herein located downstream of an internal combustion engine, such as a gasoline engine.

In yet another aspect, the invention provides a method for treating an exhaust gas comprising hydrocarbons and carbon monoxide, the method comprising contacting the exhaust gas with the automotive catalyst composite of any of the embodiments set forth herein.

In a still further aspect, the invention provides a method of making an automotive catalyst composite, the method comprising, for example, obtaining a plurality of particles in an aqueous suspension for a core structure, the particles having a primary particle size distribution d₉₀ of up to about 5 μm and comprising one or more metal oxides; obtaining a solution of nanoparticles of one or more metal oxides having a primary particle size distribution d₉₀ in the range of about 5 nm to about 1000 nm (1 μm); mixing the aqueous suspension for the core structure and the solution of nanoparticles to form a mixture; spray-drying the mixture for form a plurality of core-shell support particles; treating the core-shell support particles with one or more platinum group metals (PGMs) to form a catalytic material; and depositing the catalytic material on a carrier. The one or more PGMs deposited on the core-shell support can be selected from the group consisting of platinum (Pt), rhodium (Rh), palladium (Pd), iridium (Ir), ruthenium (Ru), and combinations thereof.

The invention also provides a particulate material adapted for use as a coating on a catalyst article, comprising a plurality of core-shell support particles comprising a core and a shell surrounding the core, wherein the core comprises a plurality of particles having a primary particle size distribution d₉₀ of up to about 5 μm, wherein the core particles comprise particles of one or more metal oxides; wherein the shell comprises nanoparticles of one or more metal oxides, wherein the nanoparticles have a primary particle size distribution d₉₀ in the range of about 5 nm to about 1000 nm (1 μm); and one or more platinum group metals (PGMs) on the core-shell support, wherein the core-shell support particles are in dry form or in aqueous slurry form.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic representation of a core-shell support particle of the invention;

FIGS. 2A-2B are scanning electron microscope (SEM) images at two different magnifications of a support of 10% ceria shell wrapping 90% lanthana/zirconia core as prepared in Example 1;

FIGS. 3A-3B are scanning electron microscope (SEM) images at two different magnifications of a support of 30% ceria shell wrapping 70% lanthana/zirconia core as prepared in Example 2;

FIG. 4 provides a representation of a two-layer wash coat structure comprising Rh on core-shell particles of the invention as prepared in Example 3;

FIG. 5 provides testing results of NO emissions versus time for two inventive materials as compared to three comparative materials after aging at 950° C.;

FIG. 6 provides testing results of HC emissions versus time for two inventive materials as compared to three comparative materials after aging at 950° C.;

FIG. 7A provides a representation of the structure of Comparative Example 4;

FIG. 7B provides a representation of a one layer wash coat structure comprising Pd supported on core-shell particles of the invention as prepared in Example 5;

FIG. 8 provides testing results of HC emissions versus time for Example 5 as compared to Comparative Example 4 after aging at 950° C.;

FIG. 9 provides testing results of NO emissions versus time for Example 5 as compared to Comparative Example 4 after aging at 950° C.;

FIG. 10A is a perspective view of a honeycomb-type substrate which may comprise an automotive catalyst composite of the invention;

FIG. 10B is a partial cross-sectional view enlarged relative to FIG. 10A and taken along a plane parallel to the end faces of the carrier of FIG. 10A, which shows an enlarged view of a plurality of the gas flow passages shown in FIG. 10A;

FIG. 11 shows a schematic depiction of an embodiment of an emission treatment system in which an automotive catalyst composite of the invention is utilized; and

FIGS. 12A-12E illustrate exemplary multi-layer catalyst structures including the automotive catalyst composite of the invention adapted for use in gasoline engine emission control systems.

### DETAILED DESCRIPTION

The invention relates to catalyst composites that include core-shell support particles that provide HC/CO oxidation and NOx abatement, the core-shell support particles including one or more platinum group metals (PGMs) supported thereon to form an integrated catalytic material. The catalyst composites include a core of a plurality of metal oxide particles and a protective porous shell of nanoparticles of a metal oxide. The core-shell support is considered porous, with exemplary embodiments having an average pore radius of greater than 30 Å as measured by N₂ porosimetry.

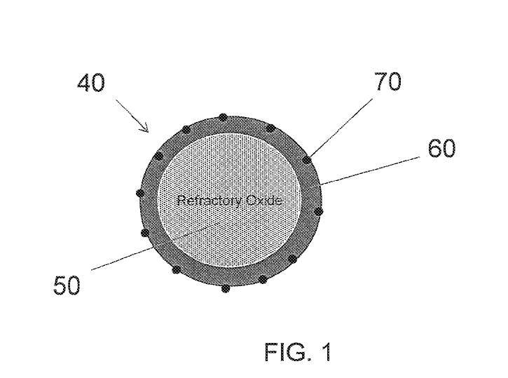

Maintaining a high PGM surface exposure is advantageous for maintaining catalytic activity after aging. In the present invention, a base metal oxide can be used as a shell coating of controlled thickness overlying a plurality of refractory oxide particles. The base metal oxide maintains the shell configuration and surface exposure due to the stability of the refractory oxide core. Therefore, doping of a PGM onto the core-shell support structure will expose the PGM to the gas-phase reactants in an exhaust stream. A representation of one embodiment of a core-shell particle 40 of the invention is set forth in FIG. 1, wherein the particle includes a plurality of core particles of metal oxide 50 surrounding by a shell of dispersed metal oxide 60, and wherein the shell is doped with a PGM component 70.

The catalyst composites of the invention provide a number of benefits in certain embodiments, such as stabilization of the core, enhanced oxidation reaction efficiency at various operating temperatures by associating the PGM component with the outer shell of the particles (where the catalytically active component will contact gas phase reagents quickly with limited diffusion required and where the particle will receive heat energy quickly), use of different metal oxide materials in the core and shell that combine various useful properties (e.g., combination of ceria as oxygen storage component with other metal oxide carriers) and which also enables one to impede migration of a PGM component within the particle (e.g., reducing migration of Rh from a shell into the core). Still further, the present invention enables the formation of a coating material of relatively uniform particle size (e.g., in the range of 5-30 or 5-20 μm), with minimal content of submicron particles (often associated with milled particles) that can limit diffusivity within a coating layer.

The present invention provides an effective method for forming a core-shell support wherein the core particles are enwrapped with a relatively thick protective layer, but the resulting particles maintain an effective particle size distribution to allow for a coating on a monolithic substrate without destroying the external shell. To accomplish this, metal oxide particles used in the core have a primary particle size distribution d₉₀ of up to about 5 μm (such as up to about 3 μm), which can be accomplished by milling commercially available metal oxide particles, which are often as large as 60-80 μm, to the desired size range (e.g., using dry or slurry milling). In addition, the shell of the core-shell particles is made using, for example, colloidal nanoparticles in a range of up to 1 μm. This range will allow for developing a shell with a desired thickness and porosity.

The invention provides core-shell support particles with a size suitable for monolith substrate coating (e.g., 5-30 μm). In certain embodiments, the core-shell support particles have a d₉₀ in the range of about 15 to about 25 μm (e.g., about 18 to about 22 μm).

Importantly, the core-shell support particles are provided in the coatable size range without the requirement of milling the core-shell particles, which would damage the shell and expose the particles of the core. Milling the particles as suggested in certain patents to achieve coatable size particles will defeat the purpose of creating a core-shell particle by exposing the core particles.

The following definitions are used herein.

As used herein, “platinum group metal (PGM) component,” “platinum (Pt) component,” “rhodium (Rh) component,” “palladium (Pd) component,” “iridium (Ir) component,” “ruthenium (Ru) component” and the like refers to the respective platinum group metal in a base metal or compound (e.g., oxide) form.

“BET surface area” has its usual meaning of referring to the Brunauer-Emmett-Teller method for determining surface area by N₂-adsorption measurements. Unless otherwise stated, “surface area” refers to BET surface area.

“Primary particles” refers to individual particles of material.

“Agglomerate” refers to an assembly of primary particles in that primary particles are clustered or adhered together.

“Primary particle size distribution d₉₀” refers to a characteristic of particles that indicates that 90% of the particles have a Feret diameter of a specified range as measured by Scanning Electron Microscopy (SEM) or Transmission Electron Microscopy (TEM).

“Wash coat” is a thin, adherent coating of a catalytic or other material applied to a substrate, such as a honeycomb flow-through monolith substrate or a filter substrate, which is sufficiently porous to permit the passage there through of the gas stream being treated.

### Core-Shell Support Particles

The automotive catalyst composite includes a plurality of core-shell support particles comprising a core and a shell surrounding the core. The core typically comprises a plurality of particles having a primary particle size distribution d₉₀ of up to about 5 μm, wherein the core particles comprise particles of one or more metal oxides. As noted above, the core structure comprises metal oxide particles, of a desired size: a primary particle size distribution d₉₀ in the range of about 0.1 μm to about 5 μm (preferably a d₉₀ in the range of about 0.25 to about 3 μm). The particles of the core may be milled from larger particles (e.g., agglomerated particles) to achieve the desired size range of primary particles. The milling of the particles, typically in slurry form, may be accomplished in a ball mill or other similar equipment, and the solids content of the slurry during milling may be, e.g., about 10-50 wt. %, more particularly about 10-40 wt. %.

“Metal oxides” refers to porous metal-containing oxide materials exhibiting chemical and physical stability at high temperatures (sometimes referred to as refractory metal oxides or refractory oxides), such as the temperatures associated with gasoline or diesel engine exhaust. Exemplary metal oxides include alumina, silica, zirconia, titania, ceria, praseodymia, tin oxide, and the like, as well as physical mixtures or chemical combinations thereof, including atomically-doped combinations and including high surface area or activated compounds such as activated alumina. Exemplary combinations of metal oxides include silica-alumina, ceria-zirconia, praseodymia-ceria, alumina-zirconia, alumina-ceria-zirconia, lanthana-alumina, lanthana-zirconia-alumina, baria-alumina, baria-lanthana-alumina, baria-lanthana-neodymia alumina, and alumina-ceria. Exemplary aluminas include large pore boehmite, gamma-alumina, and delta/theta alumina. Useful commercial aluminas used as starting materials in exemplary processes include activated aluminas, such as high bulk density gamma-alumina, low or medium bulk density large pore gamma-alumina, and low bulk density large pore boehmite and gamma-alumina, available from BASF Catalysts LLC (Port Allen, La., USA).

High surface area metal oxide supports, such as alumina support materials, also referred to as “gamma alumina” or “activated alumina,” typically exhibit a BET surface area in excess of 60 m²/g, often up to about 200 m²/g or higher. Such activated alumina is usually a mixture of the gamma and delta phases of alumina, but may also contain substantial amounts of eta, kappa and theta alumina phases. “BET surface area” has its usual meaning of referring to the Brunauer, Emmett, Teller method for determining surface area by N₂ adsorption. Desirably, the active alumina has a specific surface area of 60 to 350 m²/g, and typically 90 to 250 m²/g.

In certain embodiments, metal oxide supports useful in the catalyst compositions disclosed herein are doped alumina materials, such as Si-doped alumina materials (including, but not limited to, 1-10% SiO₂—Al₂O₃), doped titania materials, such as Si-doped titania materials (including, but not limited to, 1-10% SiO₂—TiO₂), or doped zirconia materials, such as Si-doped ZrO₂ (including, but not limited to, 5-30% SiO₂—ZrO₂).

Although alumina and zirconia may have some protective effect as the primary metal oxide of the core or the shell, in some embodiments, such materials would not be highly effective at high aging conditions as observed in certain gasoline or diesel engines (e.g., at temperatures equal or greater than 850° C.). In such cases, it can be advantageous to use a metal oxide with one or more additional metal oxide dopants, such as lanthana, baria, strontium oxide, calcium oxide, magnesium oxide, and combinations thereof. The metal oxide dopant is typically present in an amount of about 1 to about 20% by weight, based on the weight of the core-shell support.

The dopant metal oxides can be introduced using an incipient wetness impregnation technique or through usage of colloidal mixed oxide particles. Particularly preferred doped metal oxides include colloidal baria-alumina, baria-zirconia, baria-titania, zirconia-alumina, baria-zirconia-alumina, lanthana-zirconia, and the like. The doping with the base metal oxides is significant to stabilize the shell particles and to maintain good PGM dispersion after severe aging conditions.

The shell structure around the core structure comprises nanoparticles of one or more of the above-noted metal oxides. Upon formation of the core-shell support by spray drying, the particles of the shell are agglomerated, which means the primary particles are clustered together to form a highly porous shell structure to allow for gas diffusion into and out of the core. The use of nanoscale size particles creates an advantageous shell coating, unlike approaches that rely on solution impregnation of a soluble aluminum or zirconium salt to form a surface coating. Accordingly, the shell structure is formed from highly dispersed nanoparticles, such as particles from a colloidal solution, having a desired size. In preferred embodiments, the primary particle size distribution d₉₀ of the colloidal solution used to form the shell is in the range of about 5 nm to about 1000 nm (1 μm), more preferably a d₉₀ in the range 20 nm to about 500 nm. It is noted that, following spray drying and calcination, the nanoparticles in the shell may agglomerate or fuse together to form larger particles with a porous structure to allow for gas diffusion into and out of the core. Accordingly, the particle size range noted above for the shell materials refers to the particle size prior to spray drying and calcination, although some discernable nanoparticles can be viewed in the final spray-dried/calcined product in many embodiments. In other embodiments, the shell will be formed of agglomerates of such nanoparticles. The crystalline structure of the shell can vary, and may include spinel, perovskite, pyrochlore, or combinations of such structures.

In certain embodiments, the shell has a thickness in the range of about 1 to about 10 μm, and preferably about 2 to about 6 μm. In one embodiment, the shell has a thickness of about 10 to about 500/0 of an average particle diameter of the core-shell support (e.g., about 20 to about 30%). Typically, the core-shell support comprises about 50 to about 95% by weight of the core (e.g., about 60 to about 90%), and about 5 to about 50% by weight of the shell (e.g., about 10 to about 30%), based on the total weight of the core-shell support. The shell thickness can be selected based, in part, on the severity of the application. For example, higher aging temperatures would require a thicker shell, such as in the range of about 5 to about 10 μm. Thickness of the core and shell can be observed and measured using Scanning Electron Microscopy (SEM) or Transmission Electron Microscopy (TEM).

For the overall core-shell support, the average particle diameter is typically in the range of about 8 μm to about 30 μm. Average particle diameter is measured by measured by light scattering techniques (dynamic light scattering or static light scattering) or by measuring particle diameters visible in Scanning Electron Microscopy (SEM).

One or more platinum group metals (PGMs) are deposited on, or otherwise associated with, the shell of the core-shell support particles. Creating a continuous shell of the desired thickness noted herein allows the deposition of PGM on the external shell and minimizes the deposition of PGM on the core particles.

As used herein, “platinum group metal” or “PGM” refers to platinum group metals or oxides thereof, including platinum (Pt), palladium (Pd), ruthenium (Ru), rhodium (Rh), osmium (Os), iridium (Ir), and mixtures thereof. In other embodiments, the platinum group metal comprises platinum, palladium or a combination thereof, such as in a weight ratio of about 1:5 to about 5:1. In certain embodiments, the PGM component is platinum only or palladium only or rhodium only. In other embodiments, the PGM component is a combination of rhodium and platinum or rhodium and palladium or platinum, palladium, and rhodium. The concentrations of PGM component (e.g., Pt, Pd, Rh, or a combination thereof) can vary, but will typically be from about 0.1 wt. % to about 5 wt. %, based on the total weight of the core-shell support.

Water-soluble compounds (e.g., precursor salts) or water-dispersible compounds (colloidal particles) or complexes of the PGM component are typically used for deposition/impregnation. Generally, both from the point of view of economics and environmental aspects, aqueous solutions of soluble compounds or complexes of the PGM component are utilized. During the calcination step, or at least during the initial phase of use of the composite, such compounds are converted into a catalytically active form of the metal or a compound thereof. Exemplary water soluble salts of PGM components include amine salts, nitrate salts, and acetate salts.

The core-shell support may be formed by spray-drying an aqueous slurry made from the core and shell structure particles. The conditions for spray-drying can include, for example, a temperature of about 150-350° C. and atmospheric pressure. The spray-dried support may then be treated with a PGM to form an integrated catalytic material. The core-shell support and/or the integrated catalytic material may then be slurried and coated without any further milling onto a carrier, for example, a flow-through honeycomb substrate or a wall-flow substrate.

Upon formation of the core-shell support by spray-drying the metal oxide particles of the core in the presence of binding particles made of colloidal shell materials (e.g., alumina, zirconia, titania, ceria, and the like), the particles of the core may be adhered together by the colloidal particles.

In certain preferred embodiments, at least one metal oxide of the core is different from at least one metal oxide of the shell. In certain embodiments, at least one of the metal oxides of the shell or core can be characterized as an oxygen storage component. An oxygen storage component (OSC) is an entity that has multi-valent oxidation states and can actively react with oxidants such as oxygen (O₂) or nitric oxides (NO₂) under oxidative conditions, or reacts with reductants such as carbon monoxide (CO), hydrocarbons (HC), or hydrogen (H₂) under reduction conditions. Examples of suitable oxygen storage components include ceria and praseodymia. An OSC is sometimes used in the form of mixed oxides. For example, ceria can be delivered as a mixed oxide of cerium and zirconium, and/or a mixed oxide of cerium, zirconium, and neodymium. For example, praseodymia can be delivered as a mixed oxide of praseodymium and zirconium, and/or a mixed oxide of praseodymium, cerium, lanthanum, yttrium, zirconium, and neodymium.

Exemplary embodiments of core-shell particles including an oxygen storage component include support particles wherein the shell comprises ceria and the core comprises at least one of zirconia, alumina, ceria-zirconia, and lanthana-zirconia (and wherein the shell comprises the one or more PGMs) or support particles wherein the shell comprises at least one of zirconia and alumina and the core comprises ceria or ceria-zirconia (and the shell comprises the one or more PGMs).

### Substrate

According to one or more embodiments, the substrate for the catalyst composition may be constructed of any material typically used for preparing automotive catalysts and will typically comprise a metal or ceramic honeycomb structure. The substrate typically provides a plurality of wall surfaces upon which a catalyst wash coat composition is applied and adhered, thereby acting as a carrier for the catalyst composition.

Exemplary metallic substrates include heat resistant metals and metal alloys, such as titanium and stainless steel as well as other alloys in which iron is a substantial or major component. Such alloys may contain one or more of nickel, chromium, and/or aluminum, and the total amount of these metals may advantageously comprise at least 15 wt. % of the alloy, e.g., 10-25 wt. % of chromium, 3-8 wt. % of aluminum, and up to 20 wt. % of nickel. The alloys may also contain small or trace amounts of one or more other metals, such as manganese, copper, vanadium, titanium and the like. The surface or the metal carriers may be oxidized at high temperatures, e.g., 1000° C. and higher, to form an oxide layer on the surface of the substrate, improving the corrosion resistance of the alloy and facilitating adhesion of the wash coat layer to the metal surface.

Ceramic materials used to construct the substrate may include any suitable refractory material, e.g., cordierite, mullite, cordierite-α alumina, silicon nitride, zircon mullite, spodumene, alumina-silica magnesia, zircon silicate, sillimanite, magnesium silicates, zircon, petalite, α alumina, aluminosilicates and the like.

Any suitable substrate may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a wash coat so that the gases flowing through the passages contact the catalytic material. The flow passages of the monolithic substrate are thin-walled channels which can be of any suitable cross-sectional shape, such as trapezoidal, rectangular, square, sinusoidal, hexagonal, oval, circular, and the like. Such structures may contain from about 60 to about 1200 or more gas inlet openings (i.e., “cells”) per square inch of cross section (cpsi), more usually from about 300 to 600 cpsi. The wall thickness of flow-through substrates can vary, with a typical range being between 0.002 and 0.1 inches. A representative commercially-available flow-through substrate is a cordierite substrate having 400 cpsi and a wall thickness of 6 mil, or 600 cpsi and a wall thickness of 4 mil. However, it will be understood that the invention is not limited to a particular substrate type, material, or geometry.

In alternative embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminum-titanate, silicon carbide and silicon nitride are also used a wall-flow filter substrates. However, it will be understood that the invention is not limited to a particular substrate type, material, or geometry. Note that where the substrate is a wall-flow substrate, the catalyst composition associated therewith (e.g., a CSF composition) can permeate into the pore structure of the porous walls (i.e., partially or fully occluding the pore openings) in addition to being disposed on the surface of the walls.

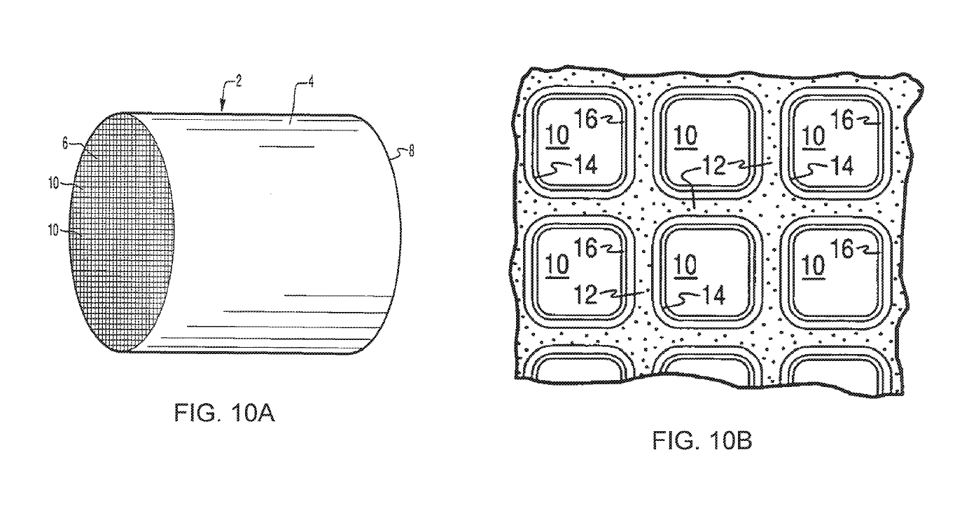

FIGS. 10A and 10B illustrate an exemplary substrate 2 in the form of a flow-through substrate coated with a wash coat composition as described herein. Referring to FIG. 10A, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 10B, flow passages 10 are formed by walls 12 and extend through carrier 2 from upstream end face 6 to downstream end face 8, the passages 10 being unobstructed so as to permit the flow of a fluid, e.g., a gas stream, longitudinally through carrier 2 via gas flow passages 10 thereof. As more easily seen in FIG. 10B, walls 12 are so dimensioned and configured that gas flow passages 10 have a substantially regular polygonal shape. As shown, the wash coat composition can be applied in multiple, distinct layers if desired. In the illustrated embodiment, the wash coat consists of both a discrete bottom wash coat layer 14 adhered to the walls 12 of the carrier member and a second discrete top wash coat layer 16 coated over the bottom wash coat layer 14. The present invention can be practiced with one or more (e.g., 2, 3, or 4) wash coat layers and is not limited to the two-layer embodiment illustrated in FIG. 10B.

In describing the quantity of wash coat or catalytic metal components or other components of the composition, it is convenient to use units of weight of component per unit volume of catalyst substrate. Therefore, the units, grams per cubic inch (“g/in³”) and grams per cubic foot (“g/ft³”), are used herein to mean the weight of a component per volume of the substrate, including the volume of void spaces of the substrate. Other units of weight per volume such as g/L are also sometimes used. The total loading of the catalyst composition on the catalyst substrate, such as a monolithic flow-through substrate, is typically from about 0.5 to about 6 g/in³, and more typically from about 1 to about 5 g/in³. Total loading of the core-shell support particles is typically about 0.5 to about 3.0 g/in³. It is noted that these weights per unit volume are typically calculated by weighing the catalyst substrate before and after treatment with the catalyst wash coat composition, and since the treatment process involves drying and calcining the catalyst substrate at high temperature, these weights represent an essentially solvent-free catalyst coating as essentially all of the water of the wash coat slurry has been removed.

A dispersion of any of the catalytic materials described herein may be used to form a slurry for a wash coat. In addition to the catalyst particles, the slurry may optionally contain alumina or other refractory metal oxides as a binder, associative thickeners, and/or surfactants (including anionic, cationic, non-ionic or amphoteric surfactants). In one embodiment, the slurry is acidic, having a pH of about 2 to less than about 7. The pH of the slurry may be lowered by the addition of an adequate amount of an inorganic or an organic acid to the slurry. Thereafter, if desired, water-soluble or water-dispersible compounds stabilizers, e.g., barium acetate, and promoters, e.g., lanthanum nitrate, may be added to the slurry. In accordance with embodiments disclosed herein, preferably the slurry requires only minimal to no subsequent milling. The carrier may then be dipped one or more times in such slurry or the slurry may be coated on the carrier such that there will be deposited on the carrier the desired loading of the wash coat. Thereafter the coated carrier is calcined by heating, e.g., at 500-600° C. for about 1 to about 3 hours. Additional layers may be prepared and deposited upon previous layers in the same manner as described above.

The automotive catalyst composite can include further components mixed with the core-shell support particles, such as a separate metal oxide component mixed with the core-shell support particles and optionally impregnated with a PGM. In one embodiment, the separate metal oxide component is selected from the group consisting of alumina, zirconia, ceria, and ceria-zirconia, optionally impregnated with a Pt component, a Pd component, a Rh component, or a combination thereof.

The automotive catalyst composite can be used as a single layer catalyst wash coat or as part of a multi-layer structure. For example, the automotive catalyst composite can be used in the form of a single layer gasoline catalyst wherein the nanoparticles of the one or more refractory metal oxides of the shell have a PGM deposited thereon. In other embodiments, the automotive catalyst composite is in the form of a multi-layer gasoline Three Way Catalyst (TWC catalyst) comprising the core-shell support particles as a first layer and a second layer overlying the first layer comprising a metal oxide, including any of the metal oxides noted herein, and an oxygen storage component (e.g., ceria-zirconia) impregnated with a PGM (e.g., a Pd component, a Rh component, or a combination thereof). In yet another embodiment, the automotive catalyst composite is used in the form of a multi-layer gasoline Three Way Catalyst (TWC catalyst) comprising the core-shell support particles as a first layer, and second layer of metal oxide impregnated with PGM (e.g., a Pt component, a Pd component, or a combination thereof), overlying the first layer, and a third layer overlying the second layer comprising a mixture of metal oxide and an oxygen storage component impregnated with a PGM (e.g., a Pd component, a Rh component, or a combination thereof).

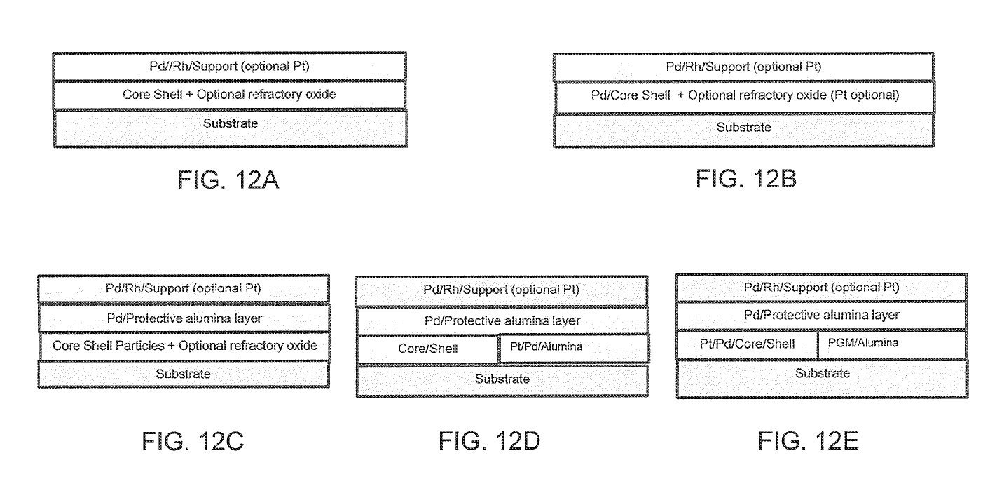

As noted above, the automotive catalyst composite can be zoned with a different catalytic material along a length of the carrier or layered with a different catalytic material on the carrier. For example, various exemplary layered and/or zoned configurations for gasoline engines are set forth in FIGS. 12A-12E. In FIG. 12A, the core-shell support particles with optional additional refractory oxide particles are coated in a first layer on the substrate and a second overlying layer comprises a support material (such as in refractory metal oxide noted herein) impregnated with palladium and rhodium and optionally platinum. Note that the support material for each PGM component can be the same or different, with exemplary different support materials including alumina, ceria-zirconia, lanthana-zirconia, and the like. FIG. 12B is similar to FIG. 12A, except it is noted that the core-shell support particles can include palladium (and optionally platinum) impregnated in the shell. FIG. 12C is similar to FIG. 12A except a middle protective alumina layer comprising palladium is placed between the outer PGM-containing layer and the inner core-shell support particle layer. FIGS. 12D and 12E are similar to FIG. 12C, except the core-shell support particles and an PGM-impregnated alumina are zone-coated as the first layer. In FIG. 12E, the zone-coated core-shell support particles further comprise PGM components impregnated into the shell.

### Emission Treatment System

The present invention also provides an emission treatment system that incorporates the catalyst compositions described herein. A catalyst article comprising the catalyst composition of the present invention is typically used in an integrated emissions treatment system comprising one or more additional components for the treatment of exhaust gas emissions. The relative placement of the various components of the emission treatment system can be varied. For example, the emission treatment system may further comprise a selective catalytic reduction (SCR) catalytic article. The treatment system can include further components, such as ammonia oxidation (AMOx) materials, ammonia-generating catalysts, and NOx storage and/or trapping components (LNTs). The preceding list of components is merely illustrative and should not be taken as limiting the scope of the invention.

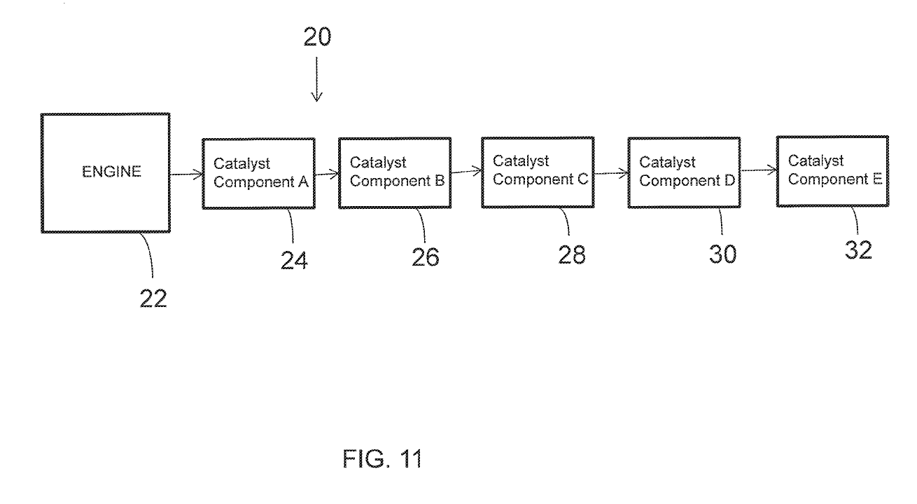

One exemplary emission treatment system is illustrated in FIG. 11, which depicts a schematic representation of an emission treatment system 20. As shown, the emission treatment system can include a plurality of catalyst components in series downstream of an engine 22 (e.g., a gasoline or lean burn gasoline engine). At least one of the catalyst components will be the oxidation catalyst of the invention as set forth herein. The catalyst composition of the invention could be combined with numerous additional catalyst materials and could be placed at various positions in comparison to the additional catalyst materials. FIG. 11 illustrates five catalyst components, 24, 26, 28, 30, 32 in series; however, the total number of catalyst components can vary and five components is merely one example. The catalyst composition of the invention could be placed in a close coupled or underfloor position of an exhaust treatment system.

Before describing several exemplary embodiments of the invention, it is to be understood that the invention is not limited to the details of construction or process steps set forth in the following description. The invention is capable of other embodiments and of being practiced in various ways. In the following, preferred designs are provided, including such combinations as recited used alone or in unlimited combinations, the uses for which include catalysts, systems, and methods of other aspects of the present invention.

### EXAMPLES

The following non-limiting examples shall serve to illustrate the various embodiments of the present invention.

### Example 1. Preparation of 10% CeO2 Shell & 90% La2O3-ZrO2 Core

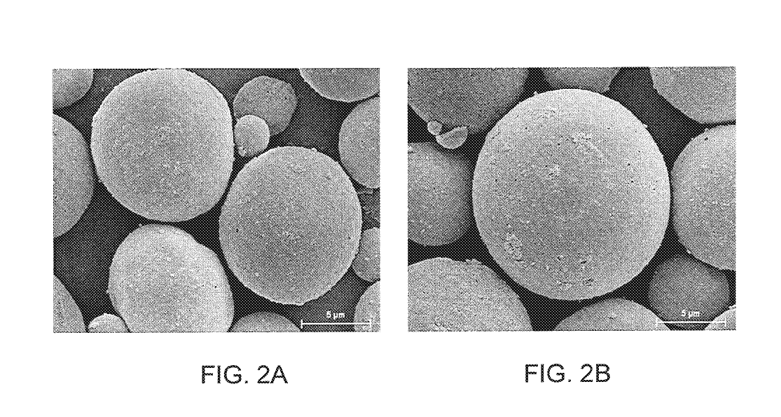

La2O3-ZrO2 core particles are composed of 8% La2O3 and 92% ZrO2. Add 750 grams of colloidal CeO2 (20% CeO2) to about 1630 grams of water. Slowly add 1369 grams of La2O3 (8%)/ZrO (92%) particles. Mix very well. Original particle size distribution at 90% (i.e., D90) is less than 65-70 μm. Mill the slurry to particle size distribution at 90% less than 4-5 μm. The final slurry properties are: pH=6.3 and solid 34.7%, and viscosity=12.5 cp. Spray dry powder the slurry to form a CeO2 shell with 10% CeO2 and core of 90% La2O3-ZrO2. Dry at 110° C. for 2 hours and calcine at 550° C. for 2 hours. Scanning electron microscope was used to determine the core-shell structure, as shown in FIGS. 2A and 2B.

### Example 2. Preparation of 30% CeO2 Shell & 70% La2O3-ZrO2 Core

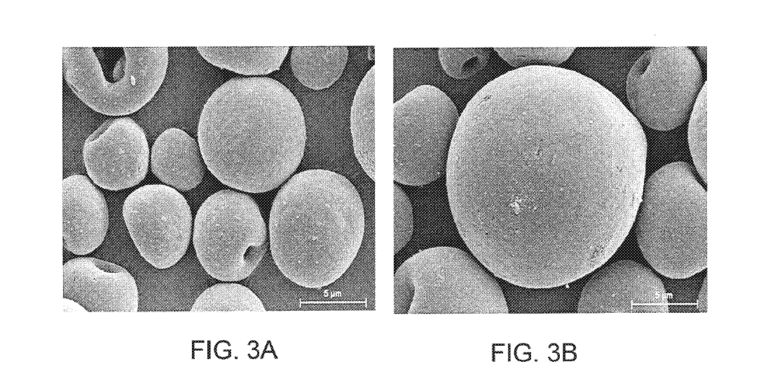

Add 2250 grams of colloidal CeO2 (20%/CeO2) to about 435 grams of water. Slowly add 1064 grams of La2O3 (8%)/ZrO (92%). Mix very well. Original particle size distribution at 90% is less than 65 μm. Mill the slurry to particle size distribution at 90% less than 4-5 μm. The final slurry properties are: pH=5.26 and solid 37.9%, and viscosity=9 cp. Spray dry powder the slurry to form a CeO2 shell with 30% CeO2 and Core of 70% La2O3-ZrO2. Dry at 110° C. for 2 hours and calcine at 550° C. for 2 hours. Scanning electron microscope was used to determine the core-shell structure, as shown in FIGS. 3A and 3B.

### Example 3. Inventive Three-Way Conversion (TWC) Catalyst Comprising Core-Shell Particles of Example 1

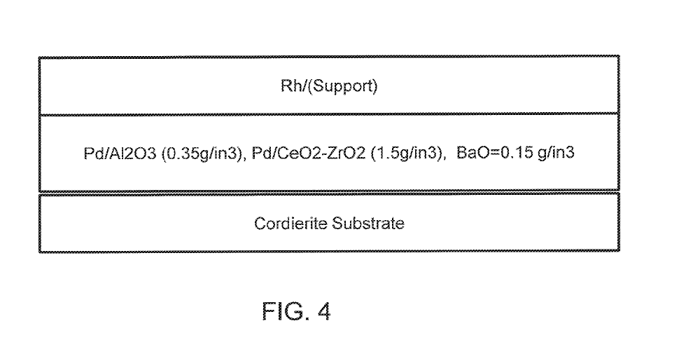

This example describes the preparation of a Three-Way Conversion (TWC) catalyst in the form of a two-layer wash coat design using inventive material described in Example 1. Separate Pd and Rh washcoats were applied onto a monolithic substrate (600 cells/in² and 4 mil wall thickness). The Pd and Rh loadings are 47 and 3 g/ft3 respectively. The same monolithic substrate was used in all examples.
a. First (Bottom) Pd Layer: Pd slurry was prepared by impregnating 30% of the Pd onto alumina followed by calcination at 550° C. The calcined Pd on alumina was then added to water to make a slurry with about 40% solids. The Pd on alumina slurry at pH of about 4-4.5 was then milled to particle size distribution at 90% less than 10-12 μm. The remaining Pd (70%) was applied onto ceria-zirconia material with composition: 40% CeO2, 50% ZrO2, and 10% La and Y oxides. The Pd on CeO2-ZrO2 was then made into a slurry (about 40% solid) and milled to particle size distribution at 90% less than 10-12 μm. The two slurries were then mixed. Zirconium nitrate and Barium sulfate were added to the combined slurry and mixed well for about 30 minutes before applying to the cordierite substrate. The Pd layer was then coated onto the substrate using standard coating techniques to give, after 550° C. calcination in air, a wash coat loading of 2.1 g/in3 with composition: Pd=0.0272 g/in3, Pd/Al₂O3=0.35 g/in3, Pd/CeO2-ZrO2=1.5 g/in3, ZrO2=0.004 g/in3, and BaO=0.15 g/in3.
b. Second (Top) Rh Layer: The Rh layer was prepared by impregnating Rh nitrate onto core-shell support particles from Example 1. The Rh was chemically fixed onto the support using mono-ethanolamine. The Rh on support was made into a slurry with about 30% solids. The slurry pH and viscosity were adjusted for good slurry theology and applied over the Pd coat. The wash coat loading after calcination was 1.04 g/in3 and composed of: Rh=0.0017 g/in3, core-shell support=1 g/in3. FIG. 4 provides a representation of the final two-layer structure, which has a total PGM loading of about 50 g/ft3 (47 g/ft3 Pd and 3 g/ft3 Rh).

### Example 4. Inventive Three-Way Conversion (TWC) Catalyst Comprising Core-Shell Particles of Example 2

a. First Pd Bottom Layer: This layer was prepared as set forth in Example 3.
b. Second Rh Top Layer: The Rh layer was prepared by impregnating Rh nitrate onto core-shell support particles from Example 2. The Rh was chemically fixed onto the support using mono-ethanol amine. The Rh on support was made into a slurry having about 30% solids. The slurry pH and viscosity were adjusted for standard slurry rheology and applied over the Pd coat. The wash coat loading after calcination was 1.04 g/in3 and composed of: Rh=0.0017 g/in3, core-shell support=1 g/in3.

### Comparative Example 1

a. First Pd Bottom Layer: This layer was prepared as set forth in Example 3.
b. Second Rh Top Layer: The Rh layer was prepared by impregnating Rh nitrate onto homogeneous CeO2-Al2O3 sample with composition of 8% CeO2 on alumina. The Rh was chemically fixed onto the 8% CeO2-Al2O3 support using mono-ethanol amine. The Rh on support was made into a slurry having 30% solids. The slurry pH and viscosity were adjusted for standard slurry rheology and applied over the Pd coat. The wash coat loading after calcination was 1.04 g/in3 and composed of: Rh=0.0017 g/in3, core-shell support=1 g/in3.

### Comparative Example 2

a. First Pd Bottom Layer: This layer was prepared as set forth in Example 3.
b. Second Rh Top Layer: The Rh layer was prepared by impregnating Rh nitrate onto another homogeneous CeO2-Al2O3 sample with composition of 10% CeO2 on alumina. The Rh was chemically fixed onto the 10% CeO2-Al2O3 support using mono-ethanol amine. The Rh on support was made into a slurry having 30% solids. The slurry pH and viscosity were adjusted for standard slurry rheology and applied over the Pd coat. The wash coat loading after calcination was 1.04 g/in3 and composed of: Rh=0.0017 g/in3, core-shell support=1 g/in3.

### Comparative Example 3

a. First Pd Bottom Layer: This layer was prepared as set forth in Example 3.
b. Second Rh Top Layer: The Rh layer was prepared by impregnating Rh nitrate onto 10% La2O3-ZrO2. This is the same material as the core material in Examples 1 and 2. The Rh was chemically fixed onto the 10% La2O3/90% ZrO2 support using mono-ethanol amine. The Rh on support was made into a slurry having 30% solids. The slurry pH and viscosity were adjusted for standard slurry rheology and applied over the Pd coat. The wash coat loading after calcination was 1.04 g/in3 and composed of: Rh=0.0017 g/in3, core-shell support=1 g/in3.

### Comparative Example 4

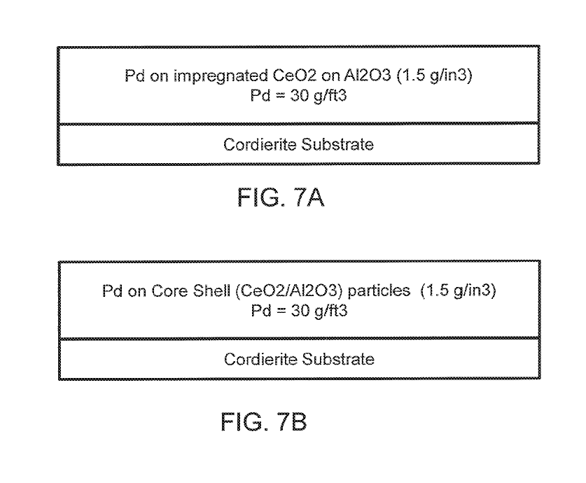

a. Preparation of 20% CeO2 on alumina: Colloidal nanoparticle ceria was impregnated onto alumina composed of 4% La2O3 and 96% alumina. The impregnated material was dried and calcined at 550° C. for 2 hours.
b. Preparation of coated catalyst (Pd catalyst): The calcined 20% CeO2 on alumina was impregnated with Pd nitrate solution. The powder was dried and calcined at 550° C. for 2 hours. The calcined material was put into water to make a slurry with about 35% solids. The material was milled to particle size distribution at 90% (i.e., d90) less than 14 μm. Colloidal alumina was added as binder to make about 4% of the slurry. The slurry was then coated onto a monolithic substrate to a wash coat loading of 1.5 g/in3. The coated catalyst was then dried and calcined at 550° C. for 2 hours. The Pd loading was about 30 g/ft3, which translates to about 1.1% Pd on the CeO2-Al2O3 support. FIG. 7A shows a representation of the final single layer structure.

### Example 5. Inventive Three-Way Conversion (TWC) Catalyst Comprising Core-Shell Particles of CeO2 Shell and Alumina Core

a. Preparation of core-shell particles: Alumina core particles composed of 4% La2O3 and 98% alumina were utilized. Colloidal CeO2 (20% CeO2) was added to water followed by the La2O3/Al2O3 particles to make a slurry with about 35-40% solids. The slurry is mixed well for 30 minutes. The original particle size distribution at 90% (i.e., d90) is less than 65-70 μm. The slurry was milled to particle size distribution at 90% less than 1-2 μm. The slurry is spray-dried to form a CeO2 shell with 20% CeO2 and core of 80% La2O3-Al2O3. The spray-dried particles were dried at 110° C. and calcined at 550° C. for 2 hours.
b. Preparation of coated catalyst (Pd catalyst): The calcined core-shell particles from Step A were impregnated with Pd nitrate solution. The powder was dried and calcined at 550° C. for 2 hours. The calcined material was mixed with water to make slurry with about 35% solids. Colloidal alumina was added as binder to make about 4% of the slurry. The slurry was then coated onto a monolithic substrate to a wash coat loading of 1.5 g/in3. The coated catalyst was then dried and calcined at 550° C. for 2 hours. The Pd loading was about 30 g/ft3, which translates to about 1.1% Pd on the CeO2-La2O3-Al2O3 support. FIG. 7B shows a representation of the final single layer structure.

### Example 6. Aging and Evaluation

The coated substrates of Examples 3-5, as well as Comparative Examples 1-4, were subjected to aging at 950° C. or 1050° C. for 5 h in 10% steam. The reactor used 1″ diameter by 1.5″ length substrate. The catalyst was tightly placed into the reactor at room temperature. The gas composition was made of: C3H8, CO/H2, NO, O2, SO2, CO2, and H2O. The CO & O2 were varied during testing to adjust the lambda conditions based on vehicle simulation. After introducing the feed into the reactor, the catalyst temperature was increased while maintaining a profile to mimic European driving cycle. The cumulative emission for HC, CO, and NOx was then plotted against time.

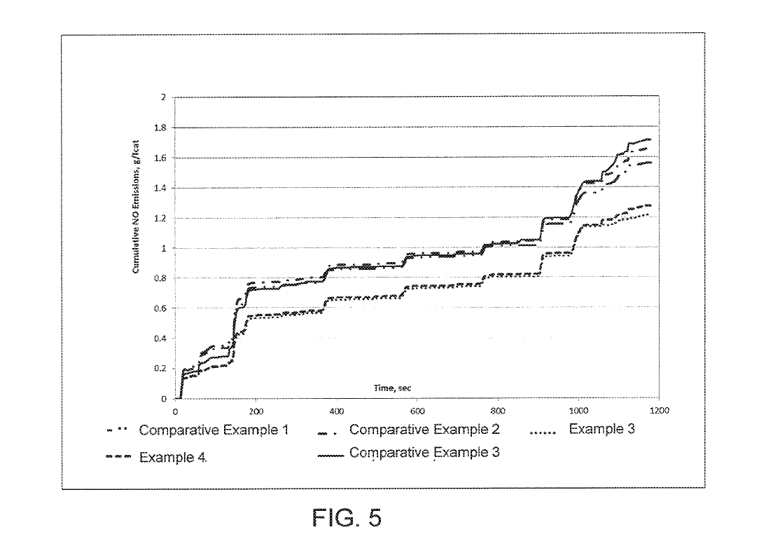

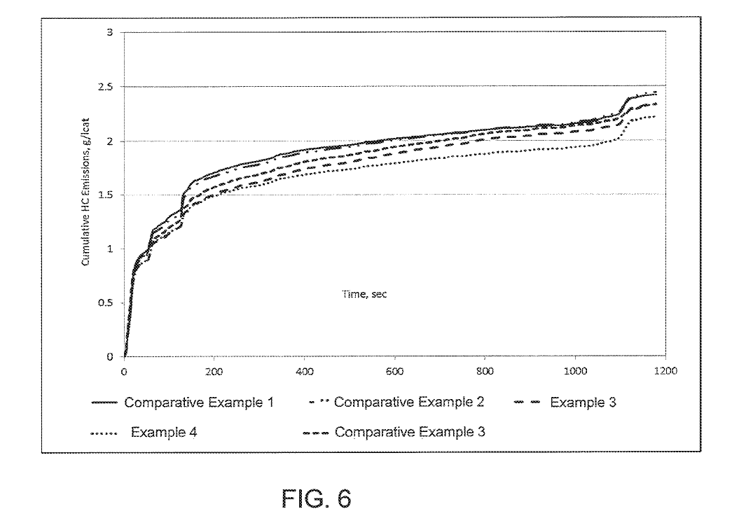

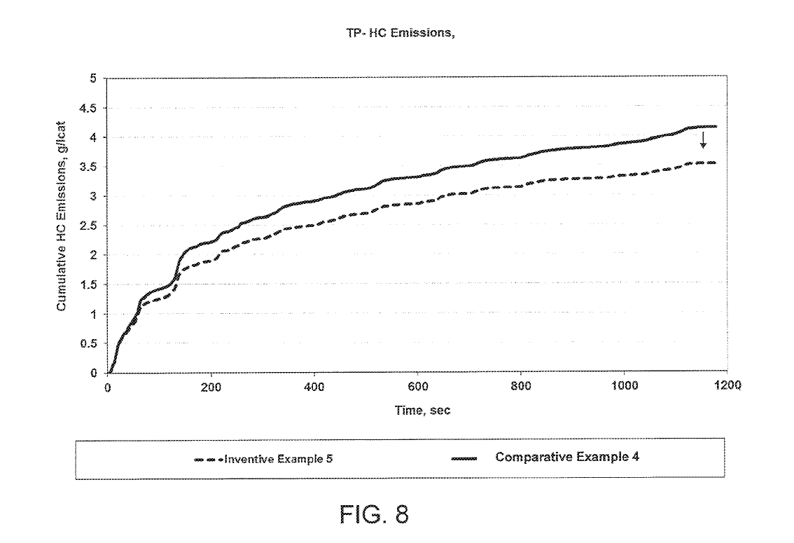

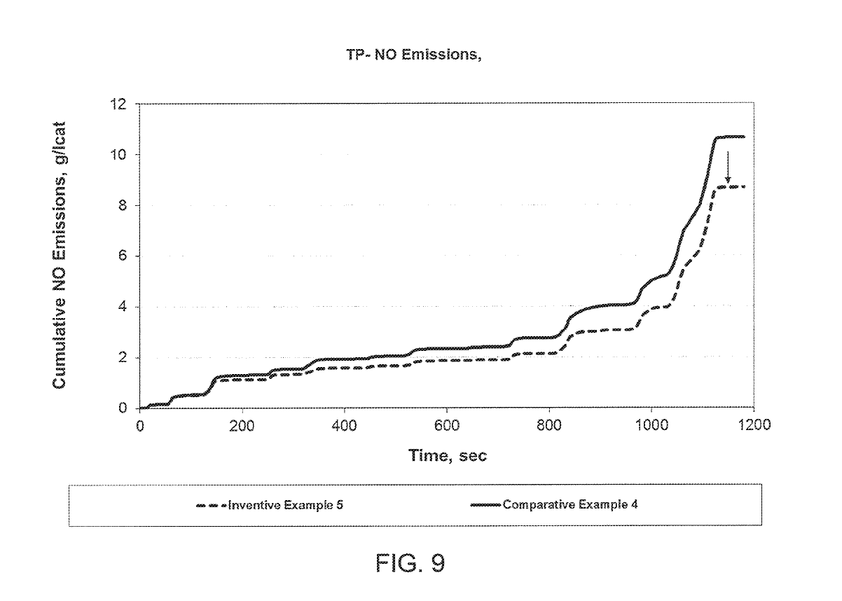

As set forth in FIGS. 5 and 9, the inventive examples containing the core-shell particles of the invention produced less cumulative NO emission than the comparative examples during the European driving cycle. Additionally, as shown in FIGS. 6 and 8, the inventive examples containing the core-shell particles of the invention produced less cumulative HC emission than the comparative examples during the European driving cycle.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

1. An automotive catalyst composite comprising:
a catalytic material on a carrier, the catalytic material comprising a plurality of core-shell support particles comprising a core and a shell surrounding the core, and one or more platinum group metals (PGMs) on the core-shell support,
wherein the core comprises a plurality of particles having a primary particle size distribution d₉₀ of up to about 5 μm, wherein the core particles comprise particles of one or more metal oxides; and
wherein the shell comprises nanoparticles of one or more metal oxides, wherein the nanoparticles have a primary particle size distribution d₉₀ in the range of about 5 nm to about 1000 nm (1 μm); and
wherein the catalytic material is effective for abating carbon monoxide, hydrocarbons, and NOx emission in an automotive exhaust gas stream.

2. The automotive catalyst composite of claim 1, wherein the shell has a thickness in the range of about 1 to about 10 μm, or wherein the shell has a thickness of about 10 to about 50% of an average particle diameter of the core-shell support.

3.-4. (canceled)

5. The automotive catalyst composite of claim 1, wherein the core has a diameter in the range of about 5 to about 20 μm.

6. The automotive catalyst composite of claim 1, wherein the core-shell support comprises about 50 to about 95% by weight of the core and about 5 to about 50% by weight of the shell, based on the total weight of the core-shell support.

7. The automotive catalyst composite of claim 1, wherein the core-shell support has an average particle diameter in the range of about 8 μm to about 30 μm.

8. (canceled)

9. The automotive catalyst composite of claim 1, wherein the metal oxide of the core comprises a metal oxide selected from the group consisting of alumina, zirconia, titania, silica, and combinations thereof, and the metal oxide of the shell has the one or more PGMs supported thereon, the metal oxide of the shell comprising a metal oxide selected from the group consisting of zirconia, titania, ceria, praseodymia, manganese oxide, lanthana, baria, gallium oxide, iron oxide, cobalt oxide, nickel oxide, zinc oxide, and combinations thereof, or wherein the metal oxide of the shell and the metal oxide of the core are independently selected from the around consisting of alumina, zirconia, titania, ceria, manganese oxide, zirconia-alumina, ceria-zirconia, ceria-alumina, lanthana-alumina, baria-alumina, silica, silica-alumina, and combinations thereof, or wherein the shell comprises ceria and the core comprises at least one of zirconia, alumina, ceria-zirconia, and lanthana-zirconia, and wherein the shell comprises the one or more PGMs, or wherein the shell comprises at least one of zirconia and alumina and the core comprises ceria or ceria-zirconia, and wherein the shell comprises the one or more PGMs.

10. (canceled)

11. The automotive catalyst composite of claim 1, wherein the shell further comprises a base metal oxide selected from the group consisting of the oxides of lanthanum, barium, praseodymium, neodymium, samarium, strontium, calcium, magnesium, niobium, hafnium, gadolinium, manganese, iron, tin, zinc, and combinations thereof.

12. The automotive catalyst composite of claim 11, wherein the base metal oxide is present in an amount of about 1 to about 20% by weight, based on the weight of the core-shell support.

13. The automotive catalyst composite of claim 1, wherein the core-shell support has an average pore radius greater than about 30 Å as measured by N₂ porosimetry.

14. The automotive catalyst composite of claim 1, wherein one or more PGMs is deposited on the shell, the PGMs being selected from the group consisting of platinum (Pt), rhodium (Rh), palladium (Pd), iridium (Ir), ruthenium (Ru), and combinations thereof.

15. (canceled)

16. The automotive catalyst composite of claim 14, wherein a weight ratio of Pt to Pd is in the range of about 5:1 to about 1:5.

17. The automotive catalyst composite of claim 14, wherein the total amount of Pt and Pd is about 0.1 to about 5% by weight, based on the total weight of the core-shell support.

18.-19. (canceled)

20. The automotive catalyst composite of claim 1, wherein the carrier is a flow-through substrate or a wall-flow filter.

21. The automotive catalyst composite of claim 1, wherein the loading of the core-shell support particles on the carrier is about 0.5 to about 3.0 g/in³.

22. The automotive catalyst composite of claim 1, further comprising a metal oxide binder.

23. The automotive catalyst composite of claim 22, wherein the metal oxide binder comprises alumina, zirconia, ceria-zirconia, or a mixture thereof.

24. The automotive catalyst composite of claim 1, further comprising a separate metal oxide component mixed with the core-shell support particles, the separate metal oxide component optionally impregnated with a PGM, wherein the separate metal oxide component is selected from the around consisting of alumina, zirconia, ceria, and ceria-zirconia, wherein the PGM is a Pt component, a Rh component, a Pd component, or a combination thereof.

25.-27. (canceled)

28. The automotive catalyst composite of claim 1, is in the form of a single layer gasoline catalyst, or in the form of a multi-layer Gasoline Three Way Catalyst (TWC catalyst) comprising the core-shell support particles as a first layer and a second layer overlying the first layer comprising a metal oxide and an oxygen storage component impregnated with a PGM, or in the form of a multi-layer gasoline Three Way Catalyst (TWC catalyst) comprising the core-shell support particles as a first layer, and a second layer of metal oxide impregnated with PGM overlying the first layer, and a third layer overlying the second layer comprising a mixture of metal oxide and an oxygen storage component impregnated with a PGM.

29. The automotive catalyst composite of claim 28, wherein the PGM of the second layer is selected from the group consisting of a Pt component, Pd component, a Rh component, and combinations thereof.

30. (canceled)

31. The automotive catalyst composite of claim 28, wherein the PGM of the third layer is selected from the group consisting of a Pt component, a Pd component, a Rh component, and combinations thereof.

32. The automotive catalyst composite of claim 1, wherein the catalytic material is zoned with a different catalytic material along a length of the carrier, or wherein the catalytic material is layered with a different catalytic material on the carrier.

33. (canceled)

34. The automotive catalyst composite of claim 1, wherein the catalytic material containing core-shell support particles is in a close coupled or underfloor position of a gasoline exhaust system.

35. (canceled)

36. An exhaust gas treatment system comprising the automotive catalyst composite of claim 1 located downstream of an internal combustion engine.

37. The exhaust gas treatment system of claim 36, wherein the internal combustion engine is a gasoline engine.

38. A method for treating an exhaust gas comprising hydrocarbons and carbon monoxide, the method comprising contacting the exhaust gas with the automotive catalyst composite of claim 1.

39. A method of making an automotive catalyst composite, the method comprising:
obtaining a plurality of particles in an aqueous suspension for a core structure, the particles having a primary particle size distribution d₉₀ of up to about 5 μm and comprising one or more metal oxides;
obtaining a solution of nanoparticles of one or more metal oxides having a primary particle size distribution d₉₀ in the range of about 5 nm to about 1000 nm (1 μm);
mixing the aqueous suspension for the core structure and the solution of nanoparticles to form a mixture;
spray-drying the mixture for form a plurality of core-shell support particles;
treating the core-shell support particles with one or more platinum group metals (PGMs) to form a catalytic material; and
depositing the catalytic material on a carrier.

40. The method of claim 39, wherein one or more PGMs are deposited on the core-shell support and are selected from the group consisting of platinum (Pt), rhodium (Rh), palladium (Pd), iridium (Ir), ruthenium (Ru), and combinations thereof.

41. A particulate material adapted for use as a coating on a catalyst article, comprising:
a plurality of core-shell support particles comprising a core and a shell surrounding the core,
wherein the core comprises a plurality of particles having a primary particle size distribution d₉₀ of up to about 5 μm, wherein the core particles comprise particles of one or more metal oxides; and
wherein the shell comprises nanoparticles of one or more metal oxides, wherein the nanoparticles have a primary particle size distribution d₉₀ in the range of about 5 nm to about 1000 nm (1 μm); and
one or more platinum group metals (PGMs) on the core-shell support, wherein the core-shell support particles are in dry form or in aqueous slurry form.
